(19) United States
(12) Patent Application Publication
(10) Pub. No.: US 2014/0333067 A1
(43) Pub. Date: Nov. 13, 2014

(54) JOINT

(71) Applicants: Tsuneyuki Okabe, Oshu-shi (JP); Shuji Moriya, Nirasaki City (JP); Kenichi Sato, Oshu-shi (JP); Tomohiro Nakata, Osaka-shi (JP); Tsutomu Shinohara, Osaka-shi (JP); Michio Yamaji, Osaka-shi (JP)

(72) Inventors: Tsuneyuki Okabe, Oshu-shi (JP); Shuji Moriya, Nirasaki City (JP); Kenichi Sato, Oshu-shi (JP); Tomohiro Nakata, Osaka-shi (JP); Tsutomu Shinohara, Osaka-shi (JP); Michio Yamaji, Osaka-shi (JP)

(73) Assignee: FUJIKIN INCORPORATED, Osaka-shi (JP)

(21) Appl. No.: 14/346,118

(22) PCT Filed: Sep. 11, 2012
(86) PCT No.: PCT/JP2012/073116

§ 371 Date: Jun. 20, 2014

(30) Foreign Application Priority Data
Sep. 22, 2011 (JP) 2011-206746

(51) Int. Cl. F16L 23/036

(52) U.S. Cl. CPC F16L 23/036
USPC 285/405

(57) ABSTRACT

Provided is a joint which can decrease the number of kinds of parts. A bolt 5 has a shaft portion 14 which is constituted of a distal end portion on which male threads 14a are formed and a remaining portion 14b on which male threads are not formed. First and second joint members 2, 3 have the same shape. A shaft insertion hole 15 which is disposed on an abutting end surface side of the joint member and a threaded hole 16 which is communicated with the shaft insertion hole 15 and extends to an end surface of the joint member on a side opposite to an abutting end surface of the joint member are formed in the first and second joint members 2, 3.

### TECHNICAL FIELD

The present invention relates to a joint such as a flange-type pipe joint.

### BACKGROUND ART

As joints, there have been well-known joints each of which includes: first and second joint members having fluid passages which are communicated with each other respectively; a seal member interposed between abutting end surfaces of both joint members; and a screw means which joins both joint members.

Among these joints, a joint referred to as a flange-type pipe joint is a joint where each joint member is constituted of a sleeve and a flange, and the joint members are joined to each other by joining the flanges to each other by a plurality of bolts. With respect to such a flange-type pipe joint, there have been known: a flange-type pipe joint where flanges of the respective joint members have the same shape and the flanges are joined to each other by bolts and nuts (patent literature 1); and a flange-type pipe joint where threaded holes are formed in one of flanges instead of nuts and the flanges are jointed to each other using only bolts (patent literature 2).

### CITATION LIST

### Patent Literature

PTL 1: Japanese Registered Utility Model 3141837

PTL 2: JP-A-63-292801

### SUMMARY OF INVENTION

### Technical Problem

With respect to the above-mentioned conventional flange-type pipe joint, the flange type pipe joint where the joint members are joined to each other by the bolts and the nuts has a drawback that the number of parts is increased by the number of nuts. On the other hand, the flange-type pipe joint which uses only the bolts has a drawback that the joint requires two kinds of flanges, that is, the flange in which bolt insertion holes are formed, and the flange in which threaded holes are formed and hence, the number of kinds of parts is not decreased.

It is an object of the present invention to provide a joint which can decrease the number of kinds of parts.

### Solution to Problem

The present invention is directed to a joint which includes: first and second joint members respectively having fluid passages which are communicated with each other; a seal member which is interposed between abutting end surfaces of both joint members; and a bolt which joins both first and second joint members to each other; wherein the bolt has a shaft portion which is constituted of a distal end portion on which male threads are formed and a remaining portion on which male threads are not formed, the first and second joint members have the same shape, and as a hole into which the bolt is inserted, a shaft insertion hole which is disposed on an abutting end surface side of the joint member and a threaded hole which is communicated with the shaft insertion hole and extends to an end surface of the joint member on a side opposite to the abutting end surface of the joint member are formed in each joint member.

While a bolt used in general has male threads on the substantially whole length of a shaft portion, the bolt according to the present invention has the shaft portion which is constituted of the distal end portion on which male threads are formed and the remaining portion on which male threads are not formed. The shaft insertion hole which is disposed on an abutting end surface side of the joint member and the threaded hole which is communicated with the shaft insertion hole and extends to the end surface of the joint member on a side opposite to the abutting end surface of the joint member are formed in each joint member. Due to such a constitution, the joint member is formed into a shape corresponding to the above-mentioned bolt, and the first and second joint members can be formed into the same shape.

A length of shaft insertion hole in the joint member, a length of the threaded hole in the joint member, a length of the bolt, and a length of the male thread of the bolt are suitably set in a mutually corresponding manner.

Although the joint of the present invention is applicable to the flange type pipe joint, for example, the joint of the present invention is not limited to the flange-type pipe joint and can be used in various applications where two members are jointed to each other.

Each joint member may be formed of one member (a flange portion for joining is integrally formed with the body in which a fluid passage is formed) or each joint member may be formed of two or more members (a circular cylindrical sleeve member whose inner periphery forms a fluid passage and a flange member which is a member separate from the sleeve member).

It is preferable that each joint member is formed of a circular cylindrical sleeve member whose inner periphery forms a passage and a flange member which is a member separate from the sleeve member, the sleeve members have the same shape, the flange members have the same shape and the shaft insertion hole and the threaded hole are formed in each flange member.

Due to such a constitution, the sleeve member and the flange member can be manufactured easily, the increase of time and efforts for manufacturing the joint can be suppressed, and the number of parts of the joint can be decreased.

### Advantageous Effects of Invention

According to the joint of the present invention, the bolt has the shaft portion which is constituted of the distal end portion on which male threads are formed and the remaining portion on which male threads are not formed, and as the hole into which the bolt is inserted, the shaft insertion hole which is disposed on an abutting end surface side of the joint member and the threaded hole which is communicated with the shaft insertion hole and extends to the end surface of the joint member on a side opposite to the abutting end surface of the joint member are formed in each joint member. Due to such a constitution, the first and the second joint members can be formed into the same shape. Accordingly, the number of parts can be decreased compared to a conventional joint where the first joint member and the second joint member have the different shapes.

### BRIEF DESCRIPTION OF DRAWINGS

FIG. 1 is a longitudinal cross-sectional view showing one embodiment of a joint according to the present invention.

FIG. 2 is a longitudinal cross-sectional view showing a state in the midst of assembling the joint according to the present invention.

FIG. 3 is a longitudinal cross-sectional view showing a flange member used in the joint according to the present invention.

### REFERENCE SIGNS LIST

(1): joint

(2), (3): joint member

(4): gasket

(5): bolt

(11) sleeve (sleeve member)

(12): flange (flange member)

(14): shaft portion

(14a): male threads

(14b): remaining portion

(15): shaft insertion hole

(16): threaded hole

### DESCRIPTION OF EMBODIMENTS

An embodiment of the present invention is explained hereinafter in conjunction with drawings.

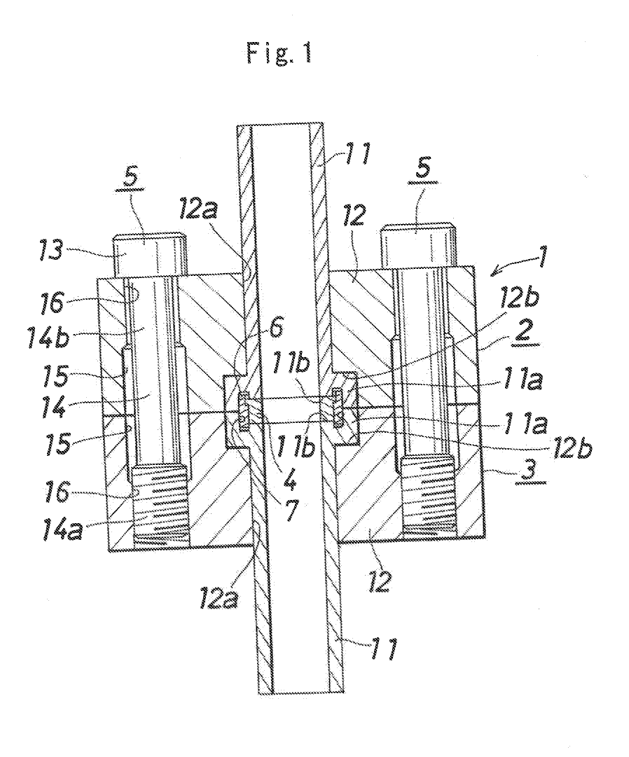

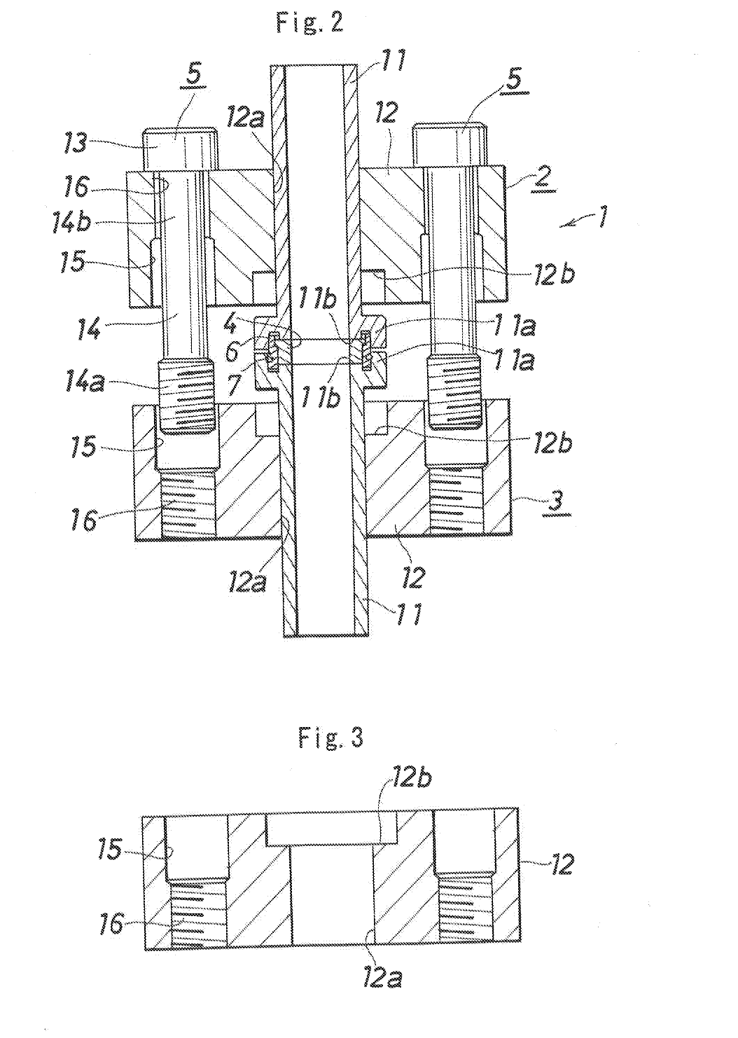

FIG. 1 and FIG. 2 show one embodiment of a joint according to the present invention. As shown in FIG. 1 and FIG. 2, a joint (1) includes: first and second joint members (2), (3) each having a fluid passage, wherein the fluid passages are communicated with each other; a circular annular gasket (4) which is interposed between both joint members (2), (3); and a plurality of (one or plural) bolts (5) which connect both joint members (2), (3).

Each of the respective joint members (2), (3) is constituted of a circular cylindrical sleeve (sleeve member) (11) whose inner periphery forms the fluid passage, and a flange (flange member) (12) which is a member separate from the sleeve (sleeve member) (11). The sleeves (11) abutting each other have the same shape, and the flanges (12) abutting each other have the same shape.

The gasket (4) is held by a retainer (6), and the retainer (6) is held on the second joint member (3) (shown on a lower side of the drawing) by means of a snap ring (7) which is made by forming a metal-made wire material having a circular cross section into a C shape.

Each of the respective bolts (5) is constituted of a head portion (13) in which a hexagonal hole is formed and a shaft portion (14). The shaft portion (14) is constituted of a distal end portion on which male threads (14a) are formed and a remaining portion (14b) on which male threads are not formed.

The sleeves (11) of the respective joint members (2) (3) abut each other, a flange portion (11a) is formed on an outer periphery of an abutting end portion of each sleeve (11), and a recessed portion (11b) for storing the gasket (4) and the retainer (5) therein is formed on an abutting end surface.

The flanges (12) of the respective joint members (2), (3) have a through hole (12a) into which the sleeve (11) is inserted, and the flanges (12) abut each other in a state where the flanges (12) are fitted on the sleeves (11) respectively. A recessed portion (12b) into which the flange portion (11a) of the sleeve (11) is fitted is formed on an inner periphery of an abutting end portion of the flange (12).

Also as shown in FIG. 3 additionally, in the flange (12), as holes into which the bolts (5) are inserted, shaft insertion holes (15) disposed on an abutting end surface side of the flange (12) and threaded holes (16) which are respectively communicated with the shaft insertion holes (15) and extend to an end surface of the flange (12) on a side opposite to the abutting end surface are formed. A length of the shaft insertion hole (15) and a length of the threaded hole (16) are set approximately equal to each other. A length of the bolt (5) is set approximately two times as large as a total length of the shaft insertion hole (15) and the threaded hole (16) and a length of the male threads (14a) of the bolt (5) is set approximately equal to the length of the threaded hole (16). It is needless to say that the length of the shaft insertion holes (15) and the length of the threaded holes (16) can be freely changed depending on the use condition and the like.

In a conventional flange-type pipe joint which uses bolts, a first flange in which shaft insertion holes are formed and a second flange in which threaded holes are formed are formed as members different from each other. To the contrary, according to this embodiment, the bolts (5) and the flanges (12) are constituted as described above and hence, the same flanges (12) having the same shape are used as the constitutional members of both joint members (2) (3). Accordingly, the number of kinds of parts can be decreased. it is necessary to define the directions of the flanges (12). That is, the pair of flanges (12) is arranged to face each other in an opposed manner in such a manner that the shaft insertion holes (15) are disposed on an abutting end surface side of the flange (12) and the threaded holes (16) are arranged on a side of the flange (12) opposite to the abutting end surface of the flange (12).

FIG. 2 shows a state of the joint (1) in the midst of assembling the joint (1). In the drawing, when the bolts (5) are aligned with and are threadedly engaged with the threaded holes (16) formed in the flange (12) from the side opposite to the abutting end surface of the first joint member (2) (from an upper side in the drawing), the male threaded portions (14a) of the bolts (5) pass through the threaded holes (16), and in a state shown in FIG. 2, the movement of the bolts (5) in the axial direction relative to the first joint member (2) is set free. Accordingly, in this state, the bolts (5) can be aligned with and be threadedly engaged with the threaded holes (16) formed in the flange (12) of the second joint member (3) from an abutting end surface side of the second joint member (3). Due to such an operation, the flanges (12), (12) of the respective joint members (2), (3) can be joined to each other. Along with such a joining operation, the flange portions (11a) of the sleeves (11) are fitted in the recessed portions (12b) formed on the abutting end portions of both flanges (12), (12) respectively. When the bolts (5) are further fastened from such a state, the sleeves (11), (11) are made to approach each other so that the gasket (4) arranged between the sleeves (11), (11) is deformed whereby a desired sealing effect can be acquired.

In FIG. 1 and FIG. 2, the bolts (5) are threadedly engaged from an upper (first) joint member (2) side. However, the bolts (5) may be threadedly engaged from a lower (second) joint member (2) side. Although a shape of the flange (flange member) (12) as viewed in the axial direction is not shown in the drawing, a shape of an outer peripheral surface of the flange (12) may be formed in a circular shape or a polygonal shape (a rectangular shape, a hexagonal shape or the like).

In above-mentioned embodiment, each of the respective joint members (2), (3) is constituted of the sleeve (11) and the flange (12). However, the constitution of the joint member is not limited to such a constitution. For example, each joint member may be formed of a single member or may be formed of three or more members. Also with respect to the shapes of the respective members, various modifications are conceivable. In short, the above-mentioned joint (1) is applicable to various usages where the joint members (2), (3) are jointed to each other using the flanges (12) and the bolts (5).

### INDUSTRIAL APPLICABILITY

By applying the joint according to the present invention to a joint such as a flange-type pipe joint, the number of kinds of parts can be decreased thus contributing to the reduction of time and efforts in connecting fluid passages and the reduction of cost.

1. A joint comprising:
first and second joint members; and
a bolt which joins both first and second joint members to each other; wherein
the bolt has a shaft portion which is constituted of a distal end portion on which male threads are formed and a remaining portion on which male threads are not formed,
the first and second joint members have the same shape, and
as a hole into which the bolt is inserted, a shaft insertion hole which is disposed on an abutting end surface side of the joint member and a threaded hole which is communicated with the shaft insertion hole and extends to an end surface of the joint member on a side opposite to the abutting end surface of the joint member are formed in each joint member.

2. The joint according to claim 1, wherein each joint member is constituted of a circular cylindrical sleeve member whose inner periphery forms a passage and a flange member which is a member separate from the sleeve member, the sleeve members have the same shape and the flange portions have the same shape, and the shaft insertion hole and the threaded hole are formed in each flange member.
